(19) United States
(12) Patent Application Publication
(10) Pub. No.: US 2024/0281288 A1
(43) Pub. Date: Aug. 22, 2024

(54) RECOMMENDATION SYSTEM FOR GATEWAY DISPATCH MECHANISM AND AUTOSCALER

(71) Applicant: Snowflake Inc., Bozeman, MT (US)

(72) Inventors: Jiajun Huang, Kenmore, WA (US); Prasanna Kumar Krishnamurthy, Sunnyvale, CA (US); Amit Kumar, Fremont, CA (US); Hari Shreedharan, San Jose, CA (US); Swapnil Taneja, Redwood City, CA (US); Michael Uhlar, Fox Island, WA (US); William Waddington, Stateline, NV (US)

(21) Appl. No.: 18/172,515

(22) Filed: Feb. 22, 2023

(51) Int. Cl. G06F 9/50

(52) U.S. Cl. CPC G06F 9/5027

(57) ABSTRACT

Described herein are techniques for improving performance of a data system by profiling and executing background services based on task type profiles. Techniques described herein can break down background services into tasks and provide the ability to accurately size the tasks based on task types and provide recommendations for gateways for autoscaling and throttling computing resources accordingly.

### TECHNICAL FIELD

The present disclosure generally relates to flexible computing, in particular autoscaling and throttling in a task based asynchronous execution framework for background services of a database system.

### BACKGROUND

Data systems, such as database systems, may be provided through a cloud platform, which allows organizations and users to store, manage, and retrieve data from the cloud. As the world becomes more data driven, database systems and other data systems are storing more and more data. For a business to use this data, foreground services, such as query executions, are typically run on this large amount of data. Some operations, for example those including large table scans, can take a substantial amount of time to execute on a large amount of data. The time to execute such operations can be related to the number of computing resources used for execution, so time can be shortened using more computing resources.

In addition to foreground services, the data systems may perform a number of background maintenance services. These background services can also use computing resources, and typically resource allocation does not accurately account for background services, which can lead to workload slowdown.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a simplified block diagram of a data system configured for throttling and autoscaling, according to some example embodiments.

FIG. 5 is a schematic block diagram of a framework for a task execution platform, according to some example embodiments.

FIG. 6 is a simplified block diagram of a task execution platform, according to some example embodiments.

FIG. 7 a flow diagram of a method for profiling a task, according to some example embodiments.

FIG. 8 is a flow diagram of a method for executing background services based on task profiling, according to some example embodiments.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein are techniques for improving performance of a data system by profiling and executing background services based on task type profiles. Conventional systems can have some techniques to plan and allocate resources for foreground services (e.g., query execution), but typically do not properly account for background services, which can consume a significant amount of computing resources. Techniques described herein can break down background services into tasks and provide the ability to accurately size the tasks based on task types and provide recommendations for gateways for throttling workloads and autoscaling computing resources accordingly. A task can be an abstraction for a unit of execution (e.g., a piece of that is run in iterations). More accurate accounting of background services, as described herein, can prevent failures of the data system due to over-subscribing and can also reduce under-utilization of valuable computing resources, thus reducing computing costs.

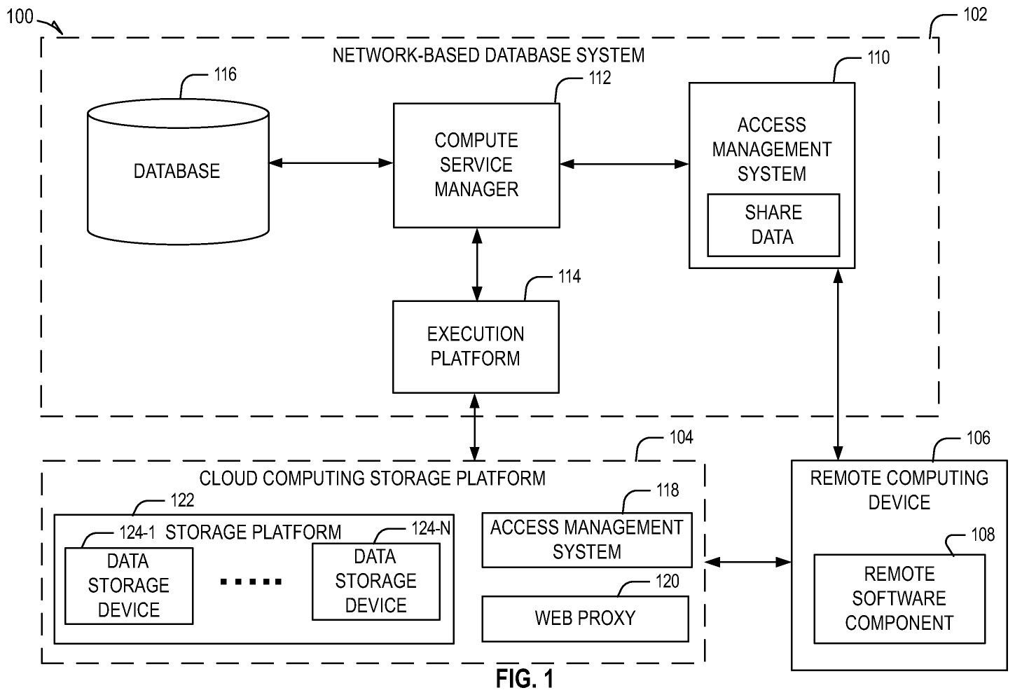

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. The shared data processing platform 100 may be provided as a data warehouse, database system, or other types of data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

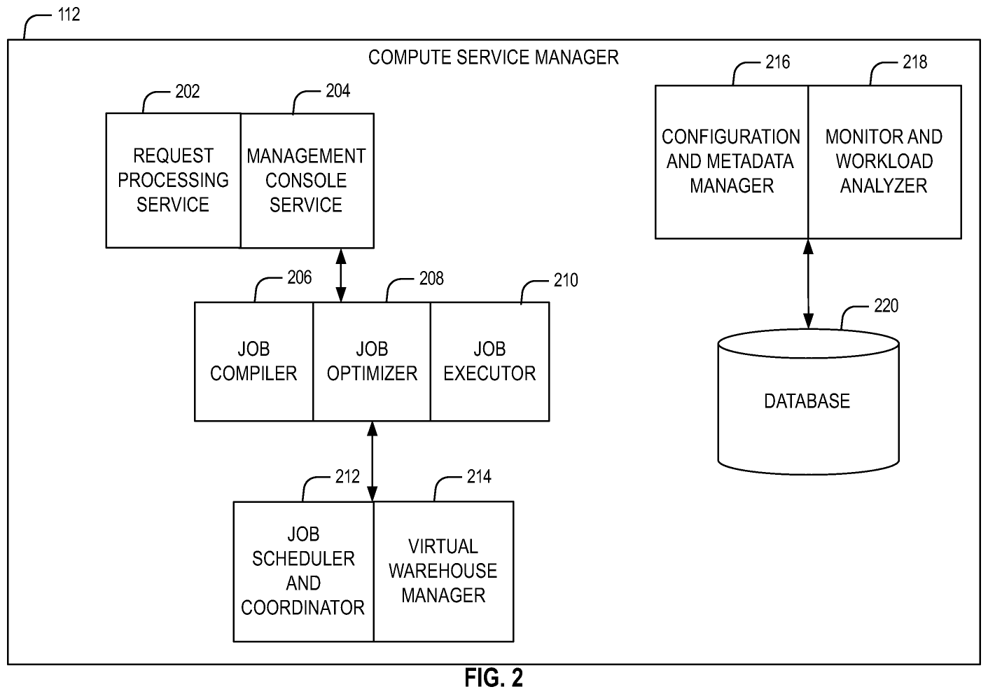

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represent any data storage device within the network-based database system 102. For example, data storage device 220 may represent caches in execution platform 114, storage devices in cloud computing storage platform 104, or any other storage device.

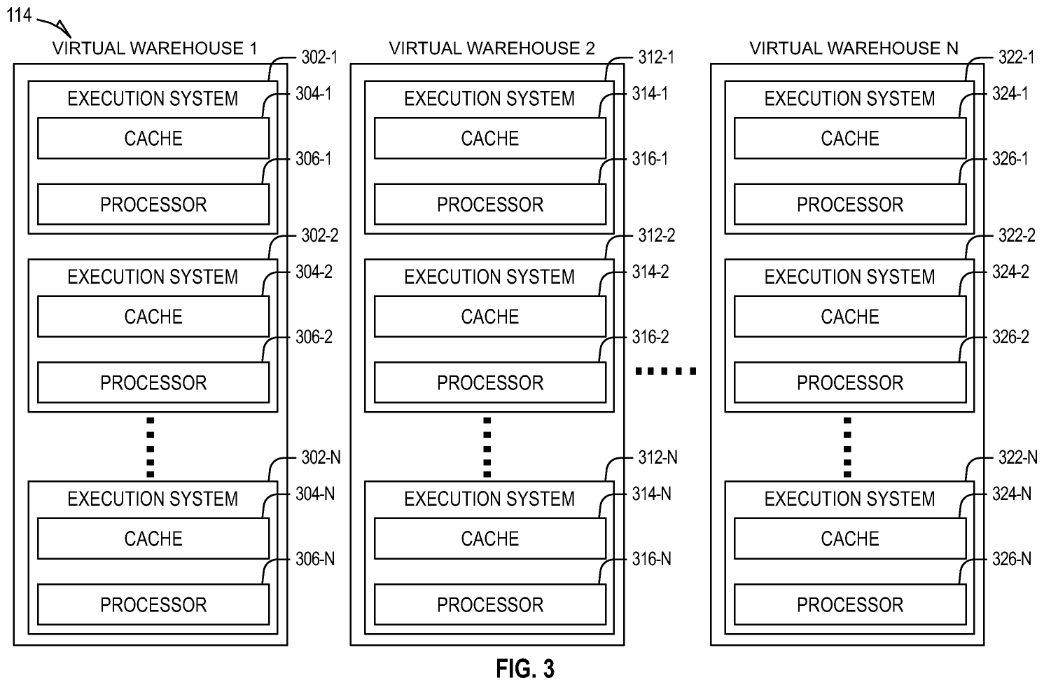

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Next, profiling and recommendation techniques for dynamic throttling and autoscaling resources for background services will be described. Background services such as maintenance services can be performed by a data system using priority-based queueing and routing asynchronous workloads related to the background services. Conventional systems typically do not accurately account for resource usages by background services, which can consume a significant amount of resources. Hence, conventional systems typically do not have the ability to throttle or autoscale computing resources based on demands of background services

Examples of background services can include file deleting operations, entity deleting operations, expression properties compaction. For example, data in a table may automatically be divided into an immutable storage device referred to as a micro-partition (also referred to as a partition). A micro-partition may be an immutable storage device in a database table that cannot be updated in-place and must be regenerated when the data stored therein is modified. A micro-partition may be considered a batch unit where each micro-partition has contiguous units of storage. By way of example, each micro-partition may contain between 50 MB and 500 MB of uncompressed data (note that the actual size in storage may be smaller because data may be stored compressed). Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. Metadata may be automatically gathered about all rows stored in a micro-partition, including: the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded. When new data is written, a new micro-partition is created and replaces an older micro-partition. Background file deleting operations can be performed to delete older micro-partitions that have been replaced. However, it should be appreciated that this disclosure of the micro-partition is exemplary only and should be considered non-limiting. It should be appreciated that the micro-partition may include other database storage devices without departing from the scope of the disclosure.

Entity deletion refers to entities such as tables and metadata being dropped. Typically, the data system marks the entities to be dropped as to be deleted in the relevant database, such as a metadata database. Then, a background service for entity deletion can be performed to delete the marked entities.

Expression properties (EP) compaction refers to compacting expression properties of a table or other data object. Expression properties of a table may include two types of files: delta EP files and compacted EP files. Delta EP files may track changes between table versions. Compacted EP files may be periodically generated when multiple delta EP files are combined and may represent one point in time.

The background services may be performed by compute service managers, as described above. The compute service managers may be grouped into clusters based on account groupings in a multi-tenant data system. In some embodiments, the compute service managers may employ execution platforms to perform some background services.

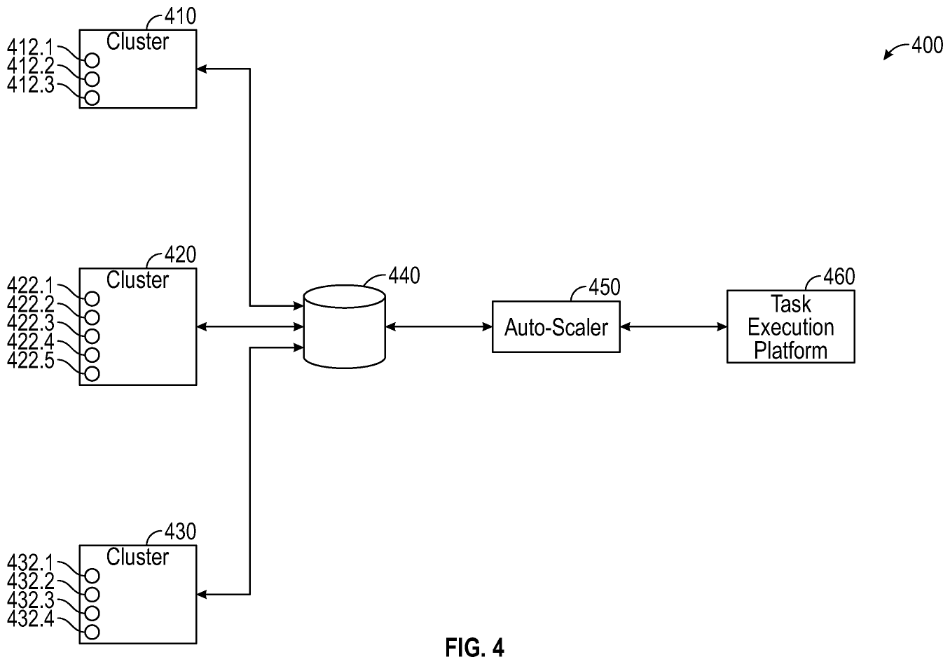

FIG. 4 shows an example of a data system configured for throttling and autoscaling, according to some example embodiments. The data system 400 may include a plurality of clusters 410, 420, 430 for performing background services. Each cluster may include a plurality of computing resources (also referred to as nodes, instances, servers). The computing resources, for example, may be provided as compute service managers as described herein. In this example, cluster 410 may include computing resources 412.1-412.3; cluster 420 may include computing resources 422.1-422.5; and cluster 430 may include computing resources 432.1-432.4. The clusters may have different number of computing and memory resources, and the number and type of computing and memory resources assigned to each cluster may change based on the autoscaling techniques, described in further detail below.

A cluster may be assigned to a group of accounts in a multi-tenancy embodiment. A cluster may be assigned to a single account in a dedicated-cluster embodiment. The computing resources may be computing nodes allocated to the data system 400 from a pool of computing nodes. In an embodiment, the computing resources may be machines, servers, CPUs, and/or processors.

The clusters 410, 420, 430 may communicate with a centralized autoscaler 450 over a network. In some embodiments, communications between the clusters 410, 420, 430 and autoscaler 450 may be performed via a metadata database 440. That is, the components in the clusters 410, 420, 430 may transmit messages, for example relating to their current workloads, to the metadata database 440, where the information from those messages may be stored. The autoscaler 450 may read the information sent by the clusters 410, 420, 430 from the metadata database 440. Also, the autoscaler may transmit messages, for example computing resource assignments, to the metadata database 440, where the information from those messages may be stored; the clusters 410, 420, 430 may then read the information sent by the autoscaler 450 from the metadata database 440.

In some other embodiments, communications between the clusters 410, 420, 430 and the autoscaler 450 may be performed directly via, for example, remote procedure calls (RPCs). Moreover, communications between the clusters 410, 420, 430 and the autoscaler 450 may be performed using a combination of direct communication (e.g., remote procedure calls) and indirect communications (e.g., via metadata database).

The autoscaler 450 may be coupled to a cloud resource provider. The cloud resource provider may maintain a pool of computing resources. The computing resources may be of different types and have different specifications. In some embodiments, the autoscaler 450 may communicate with a communication layer over the cloud resource provider.

Dynamic throttling of tasks may be provided with centralized autoscaling. Dynamic throttling may be implemented by each computing resource of a data system (e.g., computing resources 412.1-412.3, 422.1-422.5, 432.1-432.4 of data system 400). Throttling may be localized at each node and may not need communications with other nodes to be implemented.

The autoscaler 450 may also be coupled to a task execution platform 460. The task execution platform 460 may provide a framework to execute background services in the form of tasks. A task can be an abstraction for a unit of execution (e.g., a piece of that is run in iterations). For example, scanning a table and generating files is an example of a function. Each task run performs the above function. There can be many task types. Each task type represents a different function to execute.

The task execution platform 460 may provide an asynchronous task-based execution framework associated with an asynchronous task queue, as described in further detail below. The task execution platform 460 may provide information (e.g., signals) for autoscaling and throttling to the autoscaler 450 based on the task load in the task execution platform 460.

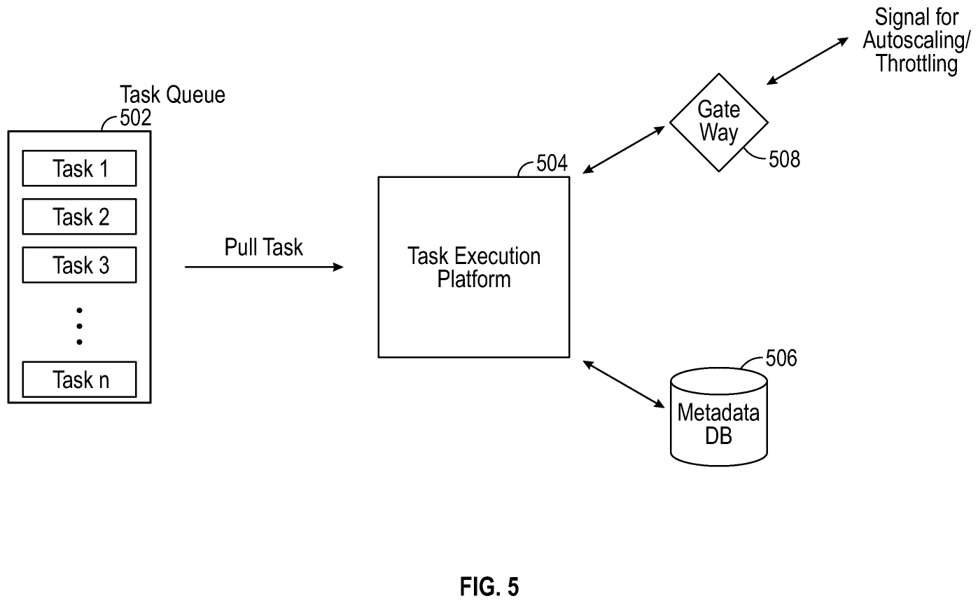

FIG. 5 illustrates a framework for a task execution platform, according to some example embodiments. A task queue 502 may be provided. The task queue 502 may be provided as an asynchronous queue. The task queue 502 may include a plurality of tasks (e.g., task 1-task n) associated with background services. The task queue 502 may be provided as a service API (e.g., RPC based API) to enqueue tasks, lease tasks, and dequeue tasks. In some embodiments, task queue 502 may be provided as a plurality of queues. The task queue 502 may manage tasks and may support delayed execution, task restart, task timeouts, and other task execution related tasks.

The tasks in the task queue 502 may be pulled from the task queue 502 by a task execution platform 504. The task execution platform 504 may be provided as part of a compute service manager, as described above. The task execution platform 504 may include an execution thread pool to execute the tasks.

The task execution platform 504 may be coupled to a metadata database 506 and a gateway 508. As discussed in further detail below, the task execution platform 504 may profile tasks and generate resource usage metrics (e.g., profiles) for different types of tasks. The resource usage metric information may be stored and updated in the metadata database 506. The task execution platform 504 may also recommend or allocate resources for task execution based on the resource usage metrics. The task execution platform 504 may monitor the task workload and provide workload information to the gateway 508. The gateway 508 may then transmit information for autoscaling or throttling of computing resources in clusters (e.g., compute service manager clusters).

The task execution platform 504 may define the size of different tasks based on profiles. In some conventional systems, system administrators can define background service tasks and the resources the tasks plan to consume. However, the system administrators cannot accurately define the size of tasks, and the tasks can go over or under the defined size, leading to over- or under-utilization of resources.

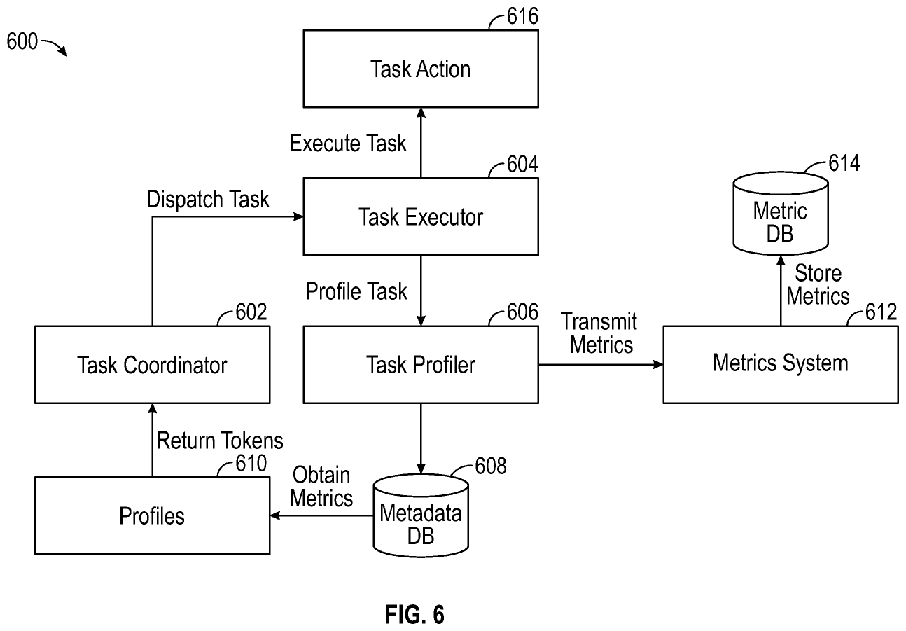

FIG. 6 illustrates a simplified block diagram of a task execution platform 600, according to some example embodiments. The task execution platform 600 may include a task coordinator 602, a task executor 604, a task profiler 606, a metadata database 608, profiles 610, a metric system 612, a metric database 614, and a task action 616.

The task coordinator 602 may pull a task from a task queue, as described above. The task coordinator 602 may categorize the task based on its task type (e.g., EP file compaction, file deletion, entity deletion, etc.). The task coordinator 602 may assign the task one or more tokens based on its task type. The tokens may represent the number and type of computing resources to be used for executing the task. The task coordinator 602 may dispatch the task to the task executor 604. The task executor 604 may execute the task using an execution thread pool in the task action 616. The number and type of computing resources assigned to execute the task may be set by the token.

The task executor 604 may also be coupled to the task profiler 606. The task profiler 606 may profile a subset of tasks. The task profiler 606 may monitor resource usage of the profiled task and the monitored information may then be used to update resource usage profiles for different task types. The task profiler 606 may collect metrics, such as CPU usage, memory usage, task execution time, number of transactions (e.g., number of transactions with a metadata database), input/output operations (such as calling cloud storage locations).

The task profiler 606 may transmit the collected metrics to the metadata database 608. The metadata database 608 may store the collected metrics. The profiles 610 may retrieve the collected metrics to build and update profiles of resource usage metrics of different task types. The profile models may include the expected resource usage of the respective task types. For example, the profile model of task type A may indicate that task type A needs 2 tokens of resource usage, and the profile model of task type B may indicate that task type B needs 4 tokens.

In some embodiments, the collected metrics may also be transmitted to the metric system 612 for further analysis. The metric system 612 may collect other information and provide more detailed analysis. The metric system 612 may store historical metric data in the metric database 614.

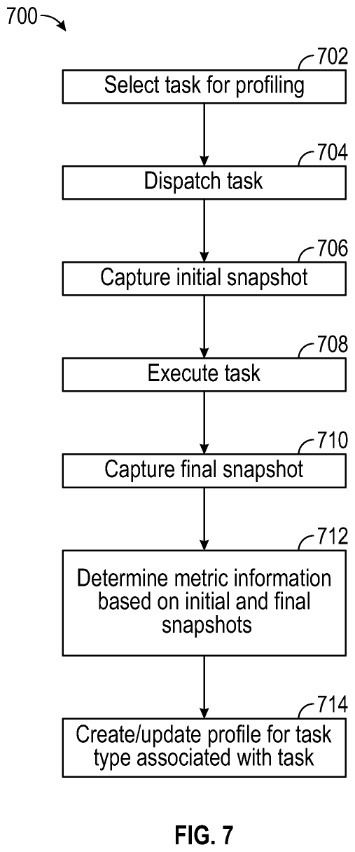

FIG. 7 is a flow diagram of a method 700 for profiling a task, according to some example embodiments. At operation 702, a task may be pulled from a task queue and selected for profiling. A subset of tasks may be selected for profiling because profiling may be resource extensive and profiling all tasks may be cumbersome. For example, count-based sampling rate may be used to select tasks to be profiled. A sampling rate may be set across all tasks. For example, a 10% sampling rate may be set so that one out of every ten tasks are profiled.

The task coordinator, for example, may record the number of samples collected for each task type. Consider an example, where the global sampling rate is 50% and there are two task types, A and B. There are 10 tasks for task type A and 20 tasks for task type B. The profiler can collect 5 task type A samples and 10 task type B samples. In some embodiments, if the number of samples collected for a certain task type reaches a maximum limit, the task coordinator may pause collecting samples for that respective task type.

In some embodiments, a probabilistic approach may be used for setting sampling ratio. A percentage may be set as a parameter. A random number may be assigned to a task, such as when a task is ready for dispatch. The random number may be compared to the set percentage. If the random number is less than the percentage, the task may be sampled. On the other hand, if the random number is greater than the percentage, the task is not sampled.

At operation 704, the task may be dispatched to one or more threads of the execution pool. The thread, and its associated computing resources, may be assigned based on the token(s) assigned to the task. As discussed herein, the token(s) may be assigned based on the profile of the task type associated with the task.

At operation 706, an initial snapshot of the execution thread may be taken. The initial snapshot may capture status information of the computing resources associated with the thread. For example, the initial snapshot may capture memory and CPU usage of the thread. The initial snapshot may also record a start time of the task execution. The initial snapshot may also capture other information such as number and durations of transactions (e.g., number and duration of transactions with a metadata database), input/output operations (such as calling cloud storage locations), XP duration statistics.

At operation 708, the task may be executed by the thread. The task may be assigned to computing resources in the thread based on the token(s), and the assigned computing resources may execute the task.

At operation 710, a final snapshot of the execution thread may be taken upon completion of the thread execution. For example, the completion of the execution thread may trigger the final snapshot. The final snapshot may capture status information of the computing resources associated with the thread. For example, the final snapshot may capture memory and CPU usage of the thread upon completion of the task execution. The final snapshot may also record an end time of the task execution. The final snapshot may also capture other information such as number of transactions (e.g., number of transactions with a metadata database), input/output operations (such as calling cloud storage locations).

At operation 712, metric information for the task execution may be determined based on the initial and final snapshots. For example, a difference of the status information in the initial and final snapshots may be taken to determine computing resource usage by the task execution.

At operation 714, a profile for the task type of the task may be created or updated based on the metric information. The profile may indicate the computing resource usage for executing the particular task type. The profile may include an assignment for a number of tokens for the particular task type. The tokens may indicate a number and type of computing resources (e.g., CPU, memory). Profiles may be created and updated for different task types. The profiles may use models and may employ machine learning algorithms.

The profiles may then be used to assign (or recommend) resources for background service tasks more accurately. The task coordinator may signal gateway information to the autoscaler to scale in/out clusters of computing resources and throttle/dethrottle new tasks accordingly, improving efficiency of the data system. Thus, the use of task profiling can prevent over- and under-utilization of resources.

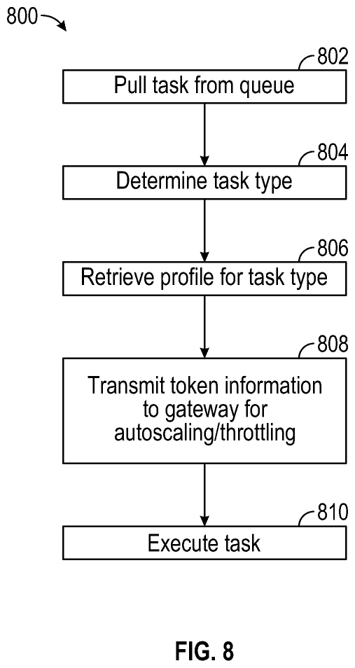

FIG. 8 is a flow diagram of a method 800 for executing background services based on task profiling, according to some example embodiments. At operation 802, a task may be pulled from the task queue. At operation 804, a task type for the pulled task may be determined. For example, a task coordinator may determine the task type for the pulled task.

At operation 806, the task coordinator may retrieve a profile associated with the determined task type. The profile may include information of the number of tokens assigned for the task type. The profile may be created and updated using task profiling techniques described above. A token may indicate the number and type of computing resources to be assigned for executing the task type.

At operation 808, information about the number of tokens from the profile may be transmitted to a gateway associated with the autoscaler. The gateway may use the information of the requested computing resources based on number of tokens to scale in or out the clusters and to throttle the tasks accordingly. For example, if the information indicates a large number of computing resources needed to execute the task where the assigned cluster does not currently include that number of available computing resources, the system may throttle the task and add more computing resources to the cluster. The task may then be put in a retry queue (e.g., task queue as described above), and the task may be retried when the cluster has been scaled out with the additional computing resources to prevent over-utilization, which can lead to system failure.

As another example, if the information indicates a small number of computing resources are needed to execute the task, the autoscaler, depending on the current size of the cluster, may scale in the cluster reducing the number of computing resources to prevent under-utilization of computing resources. At operation 810, the task may be executed.

With the profiling and feedback mechanisms described above, the data system can ensure that enough resources are allocated for execution of a background task and under-utilization is avoided by scaling resources that are not being used. As mentioned above, conventional systems do not properly account for background load and therefore are not able to achieve this level of efficient processing.

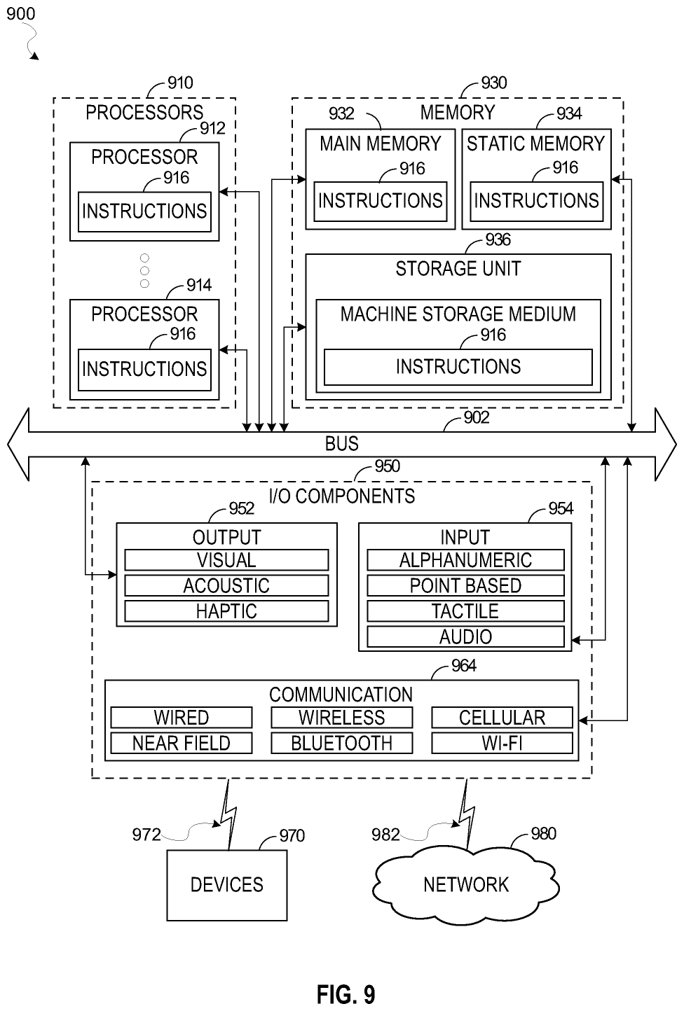

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute any one or more operations of any one or more of the methods described herein. As another example, the instructions 916 may cause the machine 900 to implement portions of the data flows described herein. In this way, the instructions 916 transform a general, non-programmed machine into a particular machine 900 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 includes processors 910, memory 930, and input/output (I/O) components 950 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, and other communication components to provide communication via other modalities. The devices 970 may be another machine or any of a wide variety of peripheral devices (e.g., a peripheral device coupled via a universal serial bus (USB)). For example, as noted above, the machine 900 may correspond to any one of the remote computing device 106, the access management system 118, the compute service manager 112, the execution platform 114, the access management system 110, the Web proxy 120, and the devices 970 may include any other of these systems and devices.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: pulling a task from a queue, the task being associated with a background service to be performed on a network-based data system; selecting the task to profile; dispatching the task to one or more assigned computing resources of an execution pool of computing resources; capturing a first snapshot of status information of the one or more assigned computing resources; executing the task using the one or more assigned computing resources; in response to completing execution of the task, capturing a second snapshot of status information of the assigned computing resources; and creating or updating a profile of a task type associated with the task based on the first and second snapshots.

Example 2. The method of example 1, wherein the status information includes information relating to CPU and memory usage.

Example 3. The method of any of examples 1-2, wherein the status information includes start and end time of the task execution.

Example 4. The method of any of examples 1-3, wherein the task is a first task, the method further comprising: pulling a second task from the queue; determining that the second task is the task type as the first task; and obtaining a token indicating a number of computing resources to be assigned for the task type based on the profile.

Example 5. The method of any of examples 1-4, further comprising: throttling the task based on the token; and adding more computing resources to a cluster assigned to execute the task.

Example 6. The method of any of examples 1-5, further comprising: adding the task to the queue in response to throttling the task; re-pulling the task from the queue; and executing the task using the cluster with the more computing resources added.

Example 7. The method of any of examples 1-6, further comprising: reducing computing resources in a cluster based on the token.

Example 8. A system comprising: one or more processors of a machine; and a memory storing instructions that, when executed by the one or more processors, cause the machine to perform operations implementing any one of example methods 1 to 7.

Example 9. A machine-readable storage device embodying instructions that, when executed by a machine, cause the machine to perform operations implementing any one of example methods 1 to 7.

1. A method comprising:
pulling a first task from one or more queues for background services, the first task being associated with a background service to be performed on a network-based data system;
selecting the first task to profile based on a sampling rate;
dispatching the first task to one or more assigned computing resources of an execution pool of computing resources;
capturing a first snapshot of status information of the one or more assigned computing resources;
executing the first task using the one or more assigned computing resources;
in response to completing execution of the first task, capturing a second snapshot of status information of the assigned computing resources;
creating or updating a profile of a task type associated with the first task based on the first and second snapshots, the profile including a number of tokens assigned for the task type, the tokens representing a number and type of computing resources;
pulling a second task from the one or more queues for background services;
determining that the second task belongs to the task type of the first task;
retrieving the profile based on determining that the second task belongs to the task type; and
assigning a set of computing resources to execute the second task based on the number of tokens in the profile.

2. The method of claim 1, wherein the status information includes information relating to CPU and memory usage.

3. The method of claim 1, wherein the status information includes start and end time of the task execution.

4. (canceled)

5. The method of claim 1, further comprising:
throttling the second task based on the number of tokens; and
adding more computing resources to a cluster assigned to execute the second task.

6. The method of claim 5, further comprising:
adding the second task to the queue in response to throttling the second task;
re-pulling the second task from the queue; and
executing the second task using the cluster with the more computing resources added.

7. The method of claim 1, further comprising:
reducing computing resources in a cluster based on the number of tokens.

8. A machine-storage medium embodying instructions that, when executed by a machine, cause the machine to perform operations comprising:
pulling a first task from one or more queues for background services, the first task being associated with a background service to be performed on a network-based data system;
selecting the first task to profile based on a sampling rate;
dispatching the first task to one or more assigned computing resources of an execution pool of computing resources;
capturing a first snapshot of status information of the one or more assigned computing resources;
executing the first task using the one or more assigned computing resources;
in response to completing execution of the first task, capturing a second snapshot of status information of the assigned computing resources;
creating or updating a profile of a task type associated with the first task based on the first and second snapshots, the profile including a number of tokens assigned for the task type, the tokens representing a number and type of computing resources;
pulling a second task from the one or more queues for background services;
determining that the second task belongs to the task type of the first task;
retrieving the profile based on determining that the second task belongs to the task type; and
assigning a set of computing resources to execute the second task based on the number of tokens in the profile.

9. The machine-storage medium of claim 8, wherein the status information includes information relating to CPU and memory usage.

10. The machine-storage medium of claim 8, wherein the status information includes start and end time of the task execution.

11. (canceled)

12. The machine-storage medium of claim 8, further comprising:
throttling the second task based on the number of tokens; and
adding more computing resources to a cluster assigned to execute the second task.

13. The machine-storage medium of claim 12, further comprising:
adding the second task to the queue in response to throttling the second task;
re-pulling the second task from the queue; and
executing the second task using the cluster with the more computing resources added.

14. The machine-storage medium of claim 8, further comprising:
reducing computing resources in a cluster based on the number of tokens.

15. A system comprising:
at least one hardware processor; and
at least one memory storing instructions that, when executed by the at least one hardware processor, cause the at least one hardware processor to perform operations comprising:
pulling a first task from one or more queues for background services, the first task being associated with a background service to be performed on a network-based data system;
selecting the first task to profile based on a sampling rate;
dispatching the first task to one or more assigned computing resources of an execution pool of computing resources;
capturing a first snapshot of status information of the one or more assigned computing resources;
executing the first task using the one or more assigned computing resources;
in response to completing execution of the first task, capturing a second snapshot of status information of the assigned computing resources;
creating or updating a profile of a task type associated with the first task based on the first and second snapshots, the profile including a number of tokens assigned for the task type, the tokens representing a number and type of computing resources;
pulling a second task from the one or more queues for background services;
determining that the second task belongs to the task type of the first task;
retrieving the profile based on determining that the second task belongs to the task type; and
assigning a set of computing resources to execute the second task based on the number of tokens in the profile.

16. The system of claim 15, wherein the status information includes information relating to CPU and memory usage.

17. The system of claim 15, wherein the status information includes start and end time of the task execution.

18. (canceled)

19. The system of claim 15, the operations further comprising:
throttling the second task based on the number of tokens; and
adding more computing resources to a cluster assigned to execute the second task.

20. The system of claim 19, the operations further comprising:
adding the second task to the queue in response to throttling the second task;
re-pulling the second task from the queue; and
executing the second task using the cluster with the more computing resources added.

21. The system of claim 15, the operations further comprising:
reducing computing resources in a cluster based on the number of tokens.
